(19) United States
(12) Patent Application Publication
(10) Pub. No.: US 2022/0072509 A1
(43) Pub. Date: Mar. 10, 2022

(54) METHOD FOR LIQUID-TO-SOLID PHASE SEPARATION OF URANIUM AND URANYL CONTAMINANT FROM VARIOUS SOLUTIONS

(71) Applicant: The Regents of the University of California, Oakland, CA (US)

(72) Inventors: Kara E. Thomas, Newport Beach, CA (US); Sarah C. Finkeldei, Irvine, CA (US); Mikael Nilsson, Dickson ACT (AU); Dmitry A. Fishman, Aliso Viejo, CA (US)

(73) Assignee: The Regents of the University of California, Oakland, CA (US)

(21) Appl. No.: 17/469,232

(22) Filed: Sep. 8, 2021

Related U.S. Application Data
(60) Provisional application No. 63/075,588, filed on Sep. 8, 2020.

(51) Int. Cl. B01J 20/26; C02F 1/42; C22B 60/02; B01J 45/00

(52) U.S. Cl. CPC B01J 20/265; C02F 1/42; C02F 2101/006; B01J 45/00; B01J 2523/397; C22B 60/026

(57) ABSTRACT

A method for separating metal ions from a liquid includes a step of providing a solution having metal-containing ions and associated negative counter ions in a liquid. The metal-containing ions are contacted with a dendrimer to form solid particles of metal-containing ion-dendrimer complexes. The solid particles of metal-containing ion-dendrimer complexes are separated from the solution.

### CROSS-REFERENCE TO RELATED APPLICATIONS

This application claims the benefit of U.S. provisional application Ser. No. 63/075,588 filed Sep. 8, 2020, the disclosure of which is hereby incorporated in its entirety by reference herein.

### STATEMENT REGARDING FEDERALLY SPONSORED RESEARCH OR DEVELOPMENT

The invention was made with Government support under Contract No. DE-NA0003180 and Contract No. DE-NA0000979 awarded by the U.S. Department of Energy (DOE). The Government has certain rights to the invention.

### TECHNICAL FIELD

In at least one aspect, the present invention is related to the separation of uranium and uranyl contaminants from various solutions.

### BACKGROUND

Uranium (U) is the heaviest naturally occurring element on earth, and the fissile property of some of its isotopes makes it an attractive element for energy applications.^{1,2} Mining, safe storage, use, and, most importantly, reuse of uranium and its isotopes are of great importance from an environmental perspective, thus are simple and efficient separation techniques.

Mining. Conventionally, uranium is obtained via ground mining for energy production in nuclear power plants. Although the concentration of uranium in groundwater and surface-water is low (approximately 3.3 ppb), the amount of uranium in the oceans totals 4 billion tons.^{3,4} Efficient mechanisms of extracting uranium directly from aqueous environments is a possible alternative to conventional ground mining—it possesses a nearly inexhaustible source of uranium.^{5,6}

Storage and Environmental Impact.

For interim and final storage of used UO₂ based fuel, cracks, corrosion, or other damages of storage containers need to be taken into consideration when a storage concept and site are evaluated. Such damages can be accelerated by radiation effects and chemical interactions between the waste and the container material and the groundwater in case of canister failure.^{7,8,9} These are some of the sources of local uranium contamination in groundwater and the oceans. Moreover, weapons production and testing, along with extensive uranium mining are contributing heavily to contamination.¹⁰ Leaking and dissolution of uranium into groundwater would necessitate the use of aqueous sequestering agents for uranium, among other radionuclides, to decrease or remove the local contamination.

Use and Recycling.

Conventional uranium mining consists of multiple separation steps to leach, separate, extract, and precipitate the element from the ore for further enrichment of the fissile isotopes.^{11,12,13} Meanwhile, after entering the nuclear fuel cycle and being used in a reactor, only part of the fissile U-235 is consumed. Segregating the remaining U from fission and activation products generated during reactor operation, e.g., plutonium (Pu), americium (Am), and others, can boost its utilization. Usually, U and Pu are co-extracted from other radio-nuclides in used fuel, and then divided into two separate steams during a standard multi-step solvent extraction re-processing technique, plutonium uranium reduction extraction (PUREX).¹⁴ Once separated, U can be re-enriched or re-processed into new fuel forms. Pu can be combined with extra uranium or plutonium from decommissioned nuclear weapons to fabricate mixed-oxide fuel (MOX) which is an alternative to the most common nuclear fuel UO₂.^{14,15,16} Thus, the efficient and direct extraction of uranium from spent nuclear fuel would allow easier re-enrichment while still minimizing nuclear proliferation concerns resulting from isolated plutonium by leaving it behind in the used fuel.¹⁷

Liquid-Liquid Separation.

Solvent extraction (SX), also known as liquid-liquid extraction (LLE), is one of the widely used methods for uranium separation from lanthanides and other actinides. This multi-step technique exploits the solubility of uranium in immiscible solutions, usually an aqueous and organic phase. By the time uranium reaches a separatory phase, whether it is in mining, re-processing, or the environment, it typically exists in an aqueous medium, in the dioxocation, uranyl (UO₂²⁺) form.¹⁸ In processes like PUREX and other re-processing or mining flowsheets, ligands are employed that induce hydrophobicity of the uranyl ion, allowing it to be selectively extracted into an organic phase.^{19,20} scrubbing process removes impurities from the organic phase by utilizing selective ligands and contacting with an aqueous phase to purify the uranyl ion. Then, the uranium is usually contacted with an aqueous phase to further isolate and reconstitute it in a concentrated form, which is called the stripping process.²¹ Despite the progress in the field, there are still many challenges of solvent extraction through LLE. Most notable is the choice of an appropriate selective ligand. Bases like oxygen donors are used as ligands for lanthanides whereas “softer” nitrogen and sulfur donors can be used for actinides and actinyls.^{22,23,24} However, similar ions are often co-extracted and need to be separated in additional steps. This can generate non-trivial amounts of secondary hazardous and/or radioactive waste at each step.^{25,26} This includes some ligands, especially in the organic phase, that can be toxic and difficult to strip and reuse, especially under the ionizing radiation fields from minor actinides and fission products present in nuclear waste.²⁷ Finally, conventional extractants still have too low of an adsorption and retention capacity to effectively reclaim low concentrations of uranium from the environment or waste streams.²⁸

Membranes and Resins.

Other uranium separation processes utilize solid support systems, such as membranes and resins. Such solid-phase extraction (SPE) techniques usually employ the principle of ion exchange (IX). In the IX process, attached or adsorbed functional group of a solid phase exchange bound ions for the targeted ions that are dissolved in the solution and brought in contact with the membrane or resin. The functional group can be any number of ligands that determine selectivity for U, as discussed with solvent extraction, but immobilization on a solid support system can offer advantages. The extractant does not have to be dissolved in the solvent, so solubility issues and generation of hazardous ligand-containing waste are mitigated. Compared with LLE, SPE has high metal ion loading capabilities because the number of functional groups or counter ions of the resin or membrane can be high per unit mass or unit volume.²⁹ In addition, modifying porosity/pore size, density, bead size, crosslinking, thickness or permeability of the membrane or resin can offer other methods of physical separation in addition to chemical processes.^{6,29} Solid supports can also be washed with different solvents for regeneration and reuse.^{29,30} Though rather effective, SPE's are not necessarily selective. For neutral pH solutions, like seawater, anion resins are typically preferred over cation resins for their selectivity for uranium in the tri-carbonate form, whereas cationic resins tend to adsorb many types of metal cations, including lanthanides and other actinides.²⁸ However, the waste stream for anionic resins usually has a delicate pH balance to form mostly anionic uranyl hydroxides or other uranium species, yet not high enough to cause precipitation of the uranium, typically over pH 8.³¹ Increased selectivity must be balanced with favorable kinetics of both adsorption and desorption.³⁰ While the flow rate over the solid support can be adjusted, many cycles of waste and washing may be needed for effective removal and reuse if the kinetics are slow, thus generating more secondary waste. In addition, the solid support is required to be highly durable under the harsh re-processing conditions. This means resistance to chemical fouling, degradation of the solid support, especially under pH extremes, delamination of the functional groups or simple saturation of the active surface.³¹

Dendrimers are branched polymers known for having multiple binding sites that can be customized via branches and size/generation (FIGS. 1A and 1B). The benefit of using dendrimers for separatory applications of metal ions from solution are enhanced due to the presence of dendritic effects.^{32,33} The steric effects, solubility, shape, and chemistry of functional groups in dendrimers can vary significantly from a monomeric or linear polymeric form of the branches.^{34,35} A previous study used crown ether-functionalized dendrimers for LLE and described these dendritic effects “positive” or “negative” based on whether they enhance or hinder extraction.³⁵ Certain dendrimers, like polyamidoamine (PAMAM) dendrimers, coordinate metal ions exceptionally well. Therefore, these systems have been proposed for many different types of metal ion sorption and extraction, including wastewater remediation and filtration, among others.^{36,37,38,39,40} Different types of functionalized solid support systems have been considered to enhance the separatory abilities of dendrimers, such as polymer ultrafiltration (PEUF) membranes,^{41,42,43} hollow fiber membranes (HFMs),⁴⁴ functionalized magnetic nanoparticles,^{45,46} resins,^{47,48,49,50} polymer hydrogels,⁵¹ functionalized silica gels,⁵² and supported liquid membranes (SLMs).⁵³ In their trivalent form, actinides undergo effective complexation with diglycoamic acid/diglycoamide (DGA)- or carbamoylmethylphosphine oxide (CMPO)-based dendrimers, and with poly(amido) amine (PAMAM)- or poly(propyleneimine) (PPI)-based dendrimers in the actinyl form. Such separation processes have been demonstrated using various solid support systems.^{43,45,47,50,53,54} In several studies, it has been noted that dendrimers with nitrogen donor groups (FIGS. 1A and 1B) have unusually high binding capacities for the uranyl ion compared to other metal ions including lanthanides or other fission products, although the exact origin of this phenomenon is yet to be understood.^{43,49,55}

Accordingly, there is a need for improved methods for extracting uranium from both naturally occurring sources and from used fuel.

### SUMMARY

In at least one aspect, a method for separating metal ions from a liquid is provided. The method includes a step of providing a solution having metal-containing ions and associated negative counter ions in a liquid. The metal-containing ions are contacted with a dendrimer to form solid particles of metal-containing ion-dendrimer complexes. The solid particles of metal-containing ion-dendrimer complexes are separated from the solution.

In another aspect, a novel separation method that utilizes the complexation of uranium from an aqueous solution phase with a dendrimer is provided. The resulting solid phase can then be easily separated from the residual solution and recycled through acid-assisted decomplexation. Such a mechanism can be easily adapted to existent inline filtration or mining systems. Moreover, the whole process can be controlled through fluorescence detection, monitoring the dendrimer and uranyl complex as well as the dendrimer concentration in solution.

In another aspect, the separation method offers an efficient complexation/separation over a rather wide pH range than LLE and SPE. To cover a similarly wide range of pH for LLE and SPE requires adjustment of the separation system, such as changing the substrate or solvent for each narrow pH region. The applicable pH range is perfect for the decontamination purposes of environmental samples, which is exceptionally challenging via LLE and SPE methods.

In another aspect, the separation method also allow a direct inline application with in situ monitoring with uranium and derivatives in liquid phases via rapid non-contact optical techniques such as fluorescence or UV-visible spectroscopy. It indicates, the separation mechanism does not rely on the absolute concentration, but on the ratio of the interacting species (uranyl:dendrimer).

In still another aspect, the separation methods set forth herein do not generate hazardous secondary waste.

In yet another aspect, an inline system for spectroscopically monitoring the presence of and/or concentration of metal-containing ions includes a conduit through which a solution having metal-containing ions and associated negative counterions, a spectrophotometer, non-contact optically radiated solution, and a dendrimer source for providing dendrimers upstream of the spectrophotometer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A and 1B. Schematic of PAMAM dendrimer structure.

FIG. 2A. Schematic flow chart showing the liquid-to-solid phase separation of a metal containing precipitate.

FIG. 2B. Schematic flow chart of an inline system for spectroscopically monitoring the presence of and/or concentration of metal-containing ions.

FIG. 3. Visual differences in precipitate formation as higher metal ion loading is achieved for the G2 PAMAM dendrimer.

FIG. 4. Excitation (blue) and emission spectrum (orange) of G2 PAMAM dendrimer solution (pH 7-7.2).

FIG. 5. Fluorescence spectrum of dendrimer (4 mM G2) and uranyl for different solution pH. Excitation wavelength centered at dendrimer absorption of 360 nm.

FIGS. 6A and 6B. Decrease in fluorescence intensity as increasing molar equivalents of uranyl ions are added. (A) decrease of fluorescence intensity for a G1 dendrimer and (B) for a G2 dendrimer.

FIGS. 7A and 7B. G2 Dendrimer spectra as an excess (ratio >1:1) of uranyl ions are added to the dendrimer solution.

FIG. 8. G1 PAMAM dendrimer shows evidence of solid phase formation separable by centrifugation at low metal loading, even if not visible to the eye.

FIG. 9. G2 PAMAM dendrimer has maximum solid phase extraction at a uranyl ion:dendrimer molar ratio of approximately 12 before uranium has saturated the dendrimer and cannot be extracted from the liquid phase.

FIG. 10. Photograph of precipitated lead-containing particles.

FIG. 11. NIR absorbance as a function of [G2 PAMAM Dendrimer]: [NpO₂₊] ratio.

FIG. 12. NIR absorbance of the redissolved precipitate as a function of [G2 PAMAM Dendrimer]:[NpO₂₊] ratio.

FIG. 13. Phase distribution of neptunyl (V) with addition of small molar amounts of G2 PAMAM dendrimer.

FIG. 14. NIR spectrum of neptunyl (VI) before and after pH adjustment, and after a small aliquot of G2 PAMAM Dendrimer is added.

FIG. 15. Comparison of NIR absorbance signal of a 0.1:1 [G2 PAMAM Dendrimer]: [NpO22+] sample immediately after the addition of dendrimer.

FIGS. 16A and 16B. NIR absorbance as a function of [G2 PAMAM Dendrimer]: [NpO₂₂₊] ratio.

FIG. 17. NIR absorbance of a 1:1 [G2 PAMAM Dendrimer]:[NpO₂₂₊] sample over time. Note: Background subtraction was performed only on the 17 hour measurement.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₅ alkyl, C₆₋₁₀ aryl, C₆₋₁₀ heteroaryl, —NO₂, —NH₂, —N(R′R″), —N(R′R″R′″)+L, Cl, F, Br, —CF₃, —CCl₃, —CN, —SO₃H, —PO₃H₂, —COOH, —CO₂R′, —COR′, —CHO, —OH, —OR′, —O-M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₈ aryl groups, M⁺ is a metal ion, and L⁻ is a negatively charged counter ion; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O-M⁺, —SO₃M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “alkali metal” means lithium, sodium, potassium, rubidium, cesium, and francium.

The “alkaline earth metal” means a chemical element in group 2 of the periodic table. The alkaline earth metals include beryllium, magnesium, calcium, strontium, barium, and radium.

The term “transition metal” means an element whose atom has a partially filled d sub-shell, or which can give rise to cations with an incomplete d sub-shell. Examples of transition metals includes scandium, titanium, vanadium, chromium, manganese, iron, cobalt, nickel, copper, yttrium, zirconium, niobium, molybdenum, technetium, ruthenium, rhodium, palladium, silver, hafnium, tantalum, tungsten, rhenium, osmium, iridium, platinum, and gold.

The term “lanthanide” or “lanthanoid series of chemical elements” means an element with atomic numbers 57-71. The lanthanides metals include lanthanum, cerium, praseodymium, samarium, europium, gadolinium neodymium, promethium, terbium, dysprosium, holmium, erbium, thulium, ytterbium, or lutetium.

The term “actinide” or “actinide series of chemical elements” means chemical elements with atomic numbers from 89 to 103. Examples of actinides includes actinium, thorium, protactinium, uranium, neptunium, and plutonium.

The term “post-transition metal” means gallium, indium, tin, thallium, lead, bismuth. zinc, cadmium, mercury, aluminum, germanium, antimony, or polonium.

The term “metal” as used herein means an alkali metal, an alkaline earth metal, a transition metal, a lanthanide, an actinide, or a post-transition metal.

The term “counter ion” refers to a negatively or positively charged ionic species that accompanies an oppositely charged ionic species in order to maintain electric neutrality. Negatively charged counter ions include inorganic counter ions and organic counter ions, including but not limited to, halide (e.g., F⁻, Cl⁻, Br⁻, I⁻), NO₃⁻, ClO₄⁻, OH⁻, H₂PO₄⁻, HSO₄⁻, a sulfonate ion (e.g., methanesulfonate, trifluoromethanesulfonate, p-tosylate, benzenesulfonate, 10-camphorsulfonate, naphthalene-2-sulfonate, naphthalene-1-sulfonic acid-5-sulfonate, ethane-1-sulfonic acid-2-sulfonate, etc.), bisulfate, butyrate, citrate, camphorate, camphorsulfonate, cyclopentanepropionate, digluconate, dodecylsulfate, ethanesulfonate, formate, fumarate, glucoheptanoate, glycerophosphate, glycolate, hemisulfate, heptanoate, hexanoate, hydrochloride, hydrobromide, hydroiodide, 2-hydroxyethanesulfonate, lactate, maleate, malonate, methanesulfonate, 2-naphthalenesulfonate, nicotinate, nitrate, oxalate, palmoate, pectinate, persulfate, 3-phenylpropionate, phosphate, picrate, pivalate, propionate, salicylate, succinate, sulfate, tartrate, thiocyanate, tosylate and undecanoate. Positively charged counter ions include, but are not limited to, alkali metal (e.g., sodium and potassium), alkaline earth metal (e.g., magnesium), ammonium and N⁺(C₁₋₄ alkyl)₄ counter ions.

Throughout this application, where publications are referenced, the disclosures of these publications in their entireties are hereby incorporated by reference into this application to more fully describe the state of the art to which this invention pertains.

### Abbreviations

“G1” means generation 1.

“G2” means generation 2.

“G3” means generation 3.

“G4” means generation 4.

“G5” means generation 5.

“G6” means generation 6.

“G7” means generation 7.

“G8” means generation 8.

“G9” means generation 9.

“G10” means generation 10.

“PAMAM” means polyamidoamine.

“SPE” means solid-phase extraction.

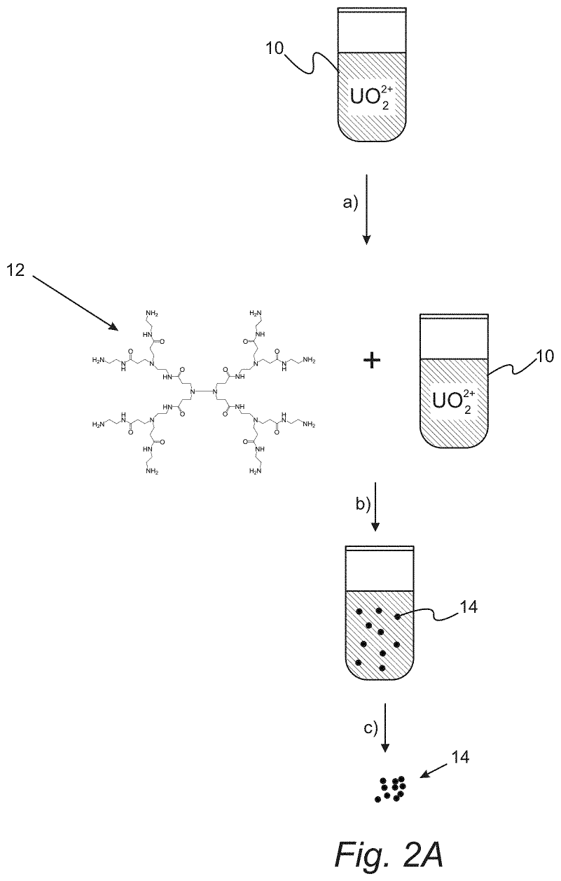

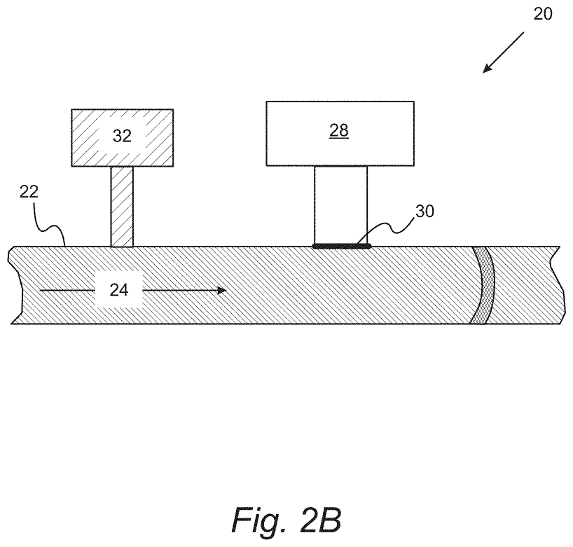

In an embodiment, a method for separating metal ions from a liquid is provided. Referring to FIG. 2, the method includes step a) of providing a solution 10 having metal-containing ions and associated negative counter ions dissolved in a liquid. In step b), the metal-containing ions are contacted with a dendrimer to form solid particles 14 of metal-containing ion-dendrimer complexes. In a refinement, the metal-containing ion-dendrimer complexes precipitate from the solution. In a further refinement, the metal-containing ion-dendrimer complexes precipitate from the solution to form a gel or slurry. In step c), the solid particles of metal-containing ion-dendrimer complexes are then separated from the solution.

In some refinements, the precipitate is visible. In this regard, the precipitate can have an average particle size greater than, in increasing order of preference, 0.1 microns, 0.2 microns, 0.3 microns, 0.4 microns, 0.5 microns, 0.6 microns, 0.7 microns, 0.8 microns, 0.9 microns, 1.0 micron, or 1.5 microns. Typically, the precipitate can have an average particle size less than 5 microns. In order to achieve the desired precipitate, the molar ratio of metal ions to dendrimer is greater than, in increasing order of preference, 0.2, 0.4, 0.5, 0.6, 0.7, 0.8, 0.9, 1.0, 2.0, 5, 10, 15, or 20. Typically, the molar ratio of metal ions to dendrimer is less than 50.

In a variation, a metal or metal-containing compounds are recovered from the solid particles of metal-containing ion-dendrimer complexes. For example, the dendrimers can be removed or separated by acid or dissolving the metal-containing ion-dendrimer complexes in a suitable solvent. Suitable solvents include water, aqueous buffers, alcohols (e.g., methanol, ethanol, propanol, benzyl alcohol, and the like.)

Typically, the dendrimer is composed of a branched carbon-chain scaffold with functional groups at regular intervals, forming a dendrimeric structure. Examples of such functional groups include nitrogen-containing groups (e.g., amines), oxygen containing groups (e.g., hydroxyl, ether), sulfur-containing groups (e.g., HS groups), and phosphine containing groups (e.g., HP). In some variation, the dendrimers can be functionalized to target specific ions in solution by changing the chemical formula of the functional groups. In one refinement, PAMAM dendrimers (e.g., PAMAM generations 0, 1, 2, 3, 4, 5, 6, 7, 8, 9, and/or 10) can be used. PAMAM dendrimers are composed of C₂₋₂₀ alkyl-diamine core and amidoamine branches (e.g., repeating branches). In a refinement, the dendrimer includes a plurality of branches attached to a core. In a refinement, the branches are tertiary amine branches. In a refinement, the core is a C₂₋₁₅ alkyl-diamine core. Examples of suitable cores include, but are not limited to, ethylenediamine, 1,2-diaminododecane, 1,4-diaminobutane, cystamine, 1,6-diaminohexane, and combinations thereof. In a further refinement, the dendrimer can include one or more surface groups. Examples of such surface groups include, but are not limited to, amidoethanol surface groups, amidoethylethanolamine surface groups, amino surface groups, hexylamide surface groups, mixed (bi-functional) surface groups, sodium carboxylate surface groups, succinamic acid surface groups, trimethoxysilyl surface groups, tris(hydroxymethyl)amidomethane surface groups, 3-carbomethoxypyrrolidinone surface groups, and combinations thereof. The dendrimers can be made in a series of repetitive steps starting with a central initiator core. Each subsequent growth step represents a subsequent “generation” of polymer with a larger molecular diameter and twice the number of reactive surface sites. In another refinement, PAMAM dendrimer is selected from the group consisting of PAMAM generation 1 dendrimers, PAMAM generation 2 dendrimers, PAMAM generation 3 dendrimers, PAMAM generation 4 dendrimers, PAMAM generation 5 dendrimers, PAMAM generation 6 dendrimers, PAMAM generation 7 dendrimers, PAMAM generation 8 dendrimers, PAMAM generation 9 dendrimers, and PAMAM generation 10 dendrimers, and combinations thereof. In a further refinement, PAMAM dendrimer is selected from the group consisting of PAMAM generation 2 dendrimers and PAMAM generation 3 dendrimers. In a further refinement, PAMAM dendrimer is PAMAM generation 2 dendrimer.

In a variation, the metal-containing ions include a metal selected from the group consisting of alkali metals, alkaline earth metals, transition metals, lanthanides, actinides, and combinations thereof. In a refinement, the metal-containing ions are lead ions, cadmium ions, copper ions, nickel ions, cobalt ions, chromium ions, or combinations thereof. In another refinement, the metal-containing ions are actinyl ions. Examples of actinyl ions include UO₂²⁺, NpO₂²⁺, PuO₂²⁺, AmO₂²⁺ (uranyl, neptunyl, plutonyl and amerinyl, respectively). In another refinement, transition metals can be separated from the solution. For example, nitrogen-containing functional groups such as pyridine can be included in the dendrimer branches to separate transition metals. Rare-earths, lanthanides, or non-actinyl actinides, can be targeted with phosphorous-containing functional groups (e.g., phosphates, phosphinic acids, phosphonic acids or phosphine oxides) included in the dendrimer branches. To coordinate alkaline earth metals (e.g., strontium, barium, or radium) sulphate functional groups can be included in the dendrimer branches. In another refinement, the metal-containing ions are lead ions (e.g., Pb²⁺ or Pb⁴⁺) such as

The solids formed by the methods set forth above can be separated from the solution by any number of solid-liquid separation techniques known to those skilled in the art. For example, in cyclone separation, a solid/liquid slurry at relatively high velocity is introduced into a conical (funnel-shaped) vessel where the solid particles concentrate close to the wall. The solid particles can be collected in a weir while the liquid passes through and exits at the bottom of the funnel. In an example of a thickening separation technique, a solid/liquid slurry can be introduced at slow velocity into a large container resembling a wide funnel. The slurry is given a long residence time allowing for the solids to settle and be removed from the bottom while the clean liquid overflow at the top. In another example, filtration can be used by placing the slurry on or in contact with a filter medium retaining the solids while liquid passes through the filter. This results in a filtrate (clear liquid) and a filter cake (solids with a small amount of liquid). In some refinements, pressure is applied to the slurry to improve phase separation and speed up the process. It should be appreciated that the separation process may deploy several separation steps in series to reduce the liquid content of the slurry.

The methods set forth herein can be used in a number of industrial and environmental applications in which separation of several metal ions is important. Uranium is important from an environmental hazard standpoint as well as a valuable resource for nuclear energy. Rare-earth elements, the lanthanide series as well as scandium and yttrium, are important for a range of industrial applications such as for high-tech industry (Nd-magnets) and light-weight alloys (scandium-aluminum alloys, e.g. Scalmalloy®). Recovering these elements from dilute liquid streams can provide cost savings. Thorium and radium (along with uranium) are naturally radioactive elements, and the presence of these elements in wastewater from oil and gas operations, as well as certain mining operations, is a major problem. The methods can also be used in other industrial operations where close to 100% recovery of the metal ions is important either from a commercial or environmental standpoint. Recovery of dilute waste streams can provide cost savings, are for example copper, lead, battery minerals (nickel and cobalt), cadmium, chromium, and the like.

In another embodiment, a composition formed by the methods set forth herein is provided. The composition includes solid particles formed by reacting a solution having metal-containing ions and associated negative counter ions with a dendrimer. Details for the metal-containing ions and the dendrimer are set forth above. In a refinement, the metal-containing ions do not include uranium. In another refinement, the metal-containing ions include uranium.

In another variation, the presence and/or concentration of the metal-containing ions in the methods set forth herein can be spectroscopically monitored. In particular, the separation method allows a direct in-line application with in situ monitoring with metal ions (e.g., uranium) and derivatives in liquid phases via rapid non-contact optical techniques such as fluorescence or absorption spectroscopy. The results set forth below indicate, the separation mechanism does not rely on the absolute concentration, but on the ratio of the interacting species (uranyl:dendrimer). Referring to FIG. 2B, a portion of an in-line system is schematically illustrated. Inline system 20 includes conduit 22 through which solution 24 having metal-containing ions and associated negative counterions s. Spectroscopic system 28 (i.e., a spectrophotometer) is in optical communication with solution 24 through window 30. Dendrimer is introduced upstream of spectroscopic system 28 from dendrimer source 32. Filter 34 is located downstream of spectroscopic system 28 to collect precipitates formed from the reaction of dendrimers with the metal ion-containing system. Examples for filter 34 are set forth above.

The following examples illustrate the various embodiments of the present invention. Those skilled in the art will recognize many variations that are within the spirit of the present invention and scope of the claims.

### 1. Uranyl Ion Separation

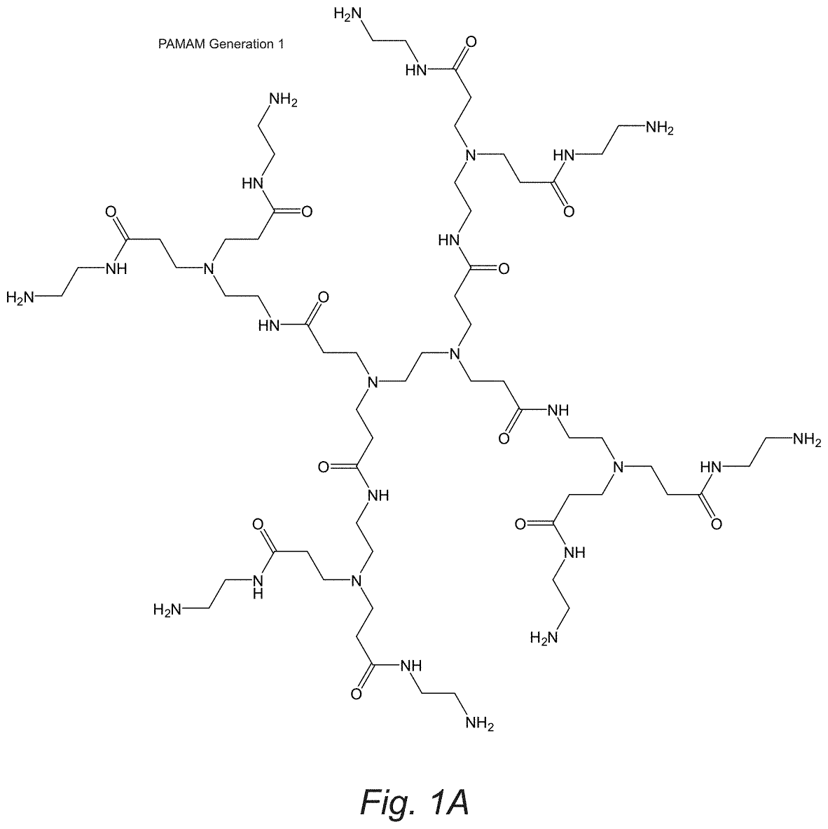

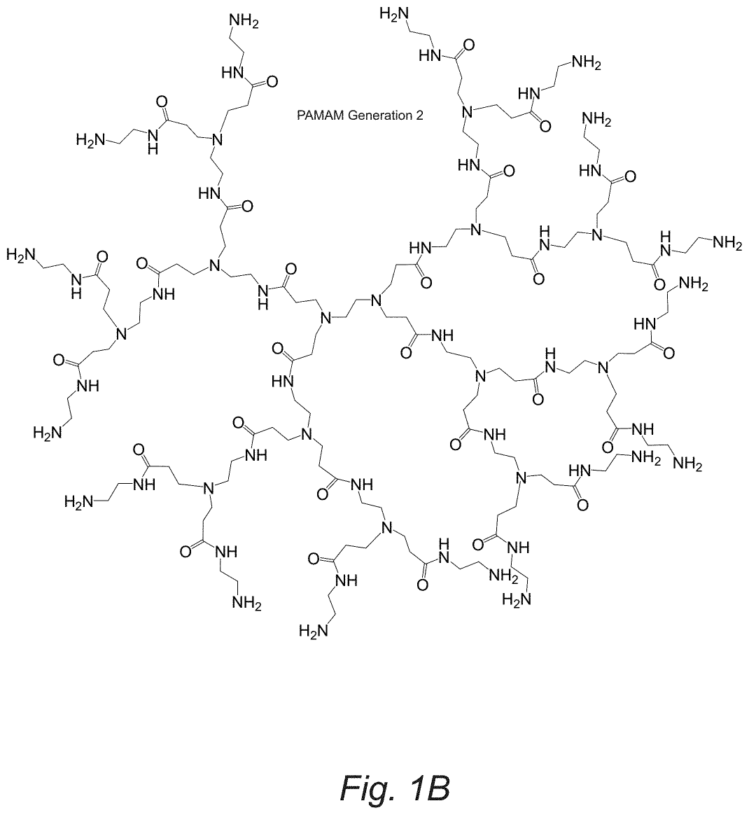

The uranyl ions can coordinate either at interior or exterior binding sites on dendrimers. The interior binding sites are referring to nitrogen donor groups that are not terminally attached to the latest generation of the molecule's outer generation (FIGS. 1A and 1B). The exact location of binding is less important as the metal loading increases with increasing numbers of generations, because—nearly all sites, i.e. internal and terminal sites, could theoretically become binding sites. It has been shown that the separatory functions of dendrimers increase with metal loading as weight and structural changes of the complex affect the colloidal properties of dendrimers.^{32,56,57,58} On the other hand, with an increase in generation/dendrimer size, dendrimers intrinsically become more globular and compact as the branches begin to interact and fold, due to dendritic effects.³⁴ Large dendrimers aggregate through the interpenetration of multiple dendrimers and even undergo self-assembly utilizing transition metals.^{58,60} The combination of the increased weight of added uranyl ion, increased structure/rigidity from metal ion coordination, and the possibility for inter and intramolecular interactions support and enable the transformation of the soft colloidal nature of the dendrimer to a much denser, extended structure that precipitates out of solution, although there is the potential loss of some binding sites. The following enables direct liquid-to-solid separation of uranyl/uranium, eliminating the need for solid support or additional separation steps—not just a simpler, but faster and more cost-effective approach. Moreover, the discussed dendrimer systems reduce the production of secondary toxic waste as is the case for LLE and SPE processes for uranyl separation^{25,26,29}.

### 1.1 Experimental Procedures

The following four stock solutions were prepared for the extraction experiments: stock solution (1) 1 M aqueous sodium nitrate solution, pH 7-7.2; stock solution (2) 4 mM GX PAMAM dendrimer (where X denotes the generation, see FIGS. 1A and 1B) in 1 M sodium nitrate solution at a pH of 7-7.2; stock solution (3) 0.01 M UO₂(NO₃)₂ in 1 M aqueous sodium nitrate solution, pH ˜3-3.2: and stock solution (4) 0.1 M UO₂(NO₃)₂ in 1 M aqueous sodium nitrate solution, pH ˜3-3.2. For complexation experiments, samples were prepared with a constant concentration of GX PAMAM dendrimer and a variable amount of uranyl ions such that the molar ratios of the uranyl ion to GX PAMAM dendrimer ranged between 0:1 (no metal ion) to >35:1 (a large excess of metal ions). Extraction experiments were performed with PAMAM dendrimers from Generation 1 to Generation 3. 2.5 mL samples were prepared using the four stock solutions. The 0.01 M UO₂(NO₃)₂ stock solution (3) was used for molar ratios of uranyl to dendrimer between 0:1 and 1:1, while the 0.1 M UO₂(NO₃)₂ stock solution (4) was used for molar ratios of uranyl to dendrimer >1:1, and the final concentrations in the samples were adjusted by the aliquots of the PAMAM and uranyl stock solutions added to the sodium nitrate stock solution.

Samples were always prepared by adding the dendrimer stock solution to the sodium nitrate stock solution, followed by mixing and subsequent addition of the uranyl stock solution aliquot to obtain the desired molar ratio of uranyl to dendrimer. Final ratios are reported as a ratio XX.X:1 relative to a 1 mM GX PAMAM solution, e.g. a 0.1:1 ratio refers to a 0.1 mM uranyl solution in a 1 mM PAMAM solution. The solutions were shaken on a vortex mixer for an hour and then left to equilibrate overnight for at least 12 hours. The pH was measured prior to analysis. The multiple amine sites of the PAMAM dendrimer tended to buffer the solutions well, and the final pH of the equilibrated samples was between pH 6.8-7.2 for all prepared samples. For low uranyl concentrations/loadings ratios of 0.5:1 or even lower uranyl concentrations, no visible precipitation occurred. For uranyl to dendrimer ratios of 1:1 or higher uranyl concentrations a yellow precipitate formation was observed. Regardless if a precipitation was observable by eye, all samples were centrifuged for 5 minutes at 4000 RPM.

The supernatant was separated from the precipitate into a clean glass vial, even if no precipitate was visible by eye the same procedure was followed. The precipitate was then dissolved in 3 mL 1 M HNO₃ which led to a clear solution.

### 1.2 Steady-State Fluorescence Experiments

Uranyl, dendrimer and their complexation have been monitored through standard fluorescence experiments using Cary Eclipse fluorimeter (Agilent) on the supernatant solution. The excitation wavelength was set at 360 nm at dendrimer absorption maxima to observe the change of dendrimer fluorescence and quenching due to the presence of U ion.

### 1.3 NAA Experiments

To determine the amount of uranyl in both the liquid phase and the solid precipitate nuclear activation analysis (NAA) was utilized. 1 mL of the supernatant and 1 mL of the re-dissolved precipitate were transferred in polyethylene vials and irradiated in the UCI TRIGA Reactor for 1 hour at 250 kW in the rotary sample position (lazy susan), with two stacked vials to each position with an estimated thermal neutron flux of 8.0*10¹¹ neutrons/s*cm². The samples were left for 24 hours to allow all the U-239 to decay to Np-239. A high purity germanium (HPGe) detector was then used to count the activity of Np-239 using the 106.1 keV gamma peak. Five UO₂(NO₃)₂ standards were used in duplicate to create a standard curve. This curve accounts for variations in the neutron flux in the stacked vials during irradiation, distance from the detector, and the efficiency of the HPGe. From the recorded standard curve, the concentration of uranium in the original sample can be back-calculated, accounting for time elapsed since the irradiation and the sample size.

### 1.4 Results and Discussions

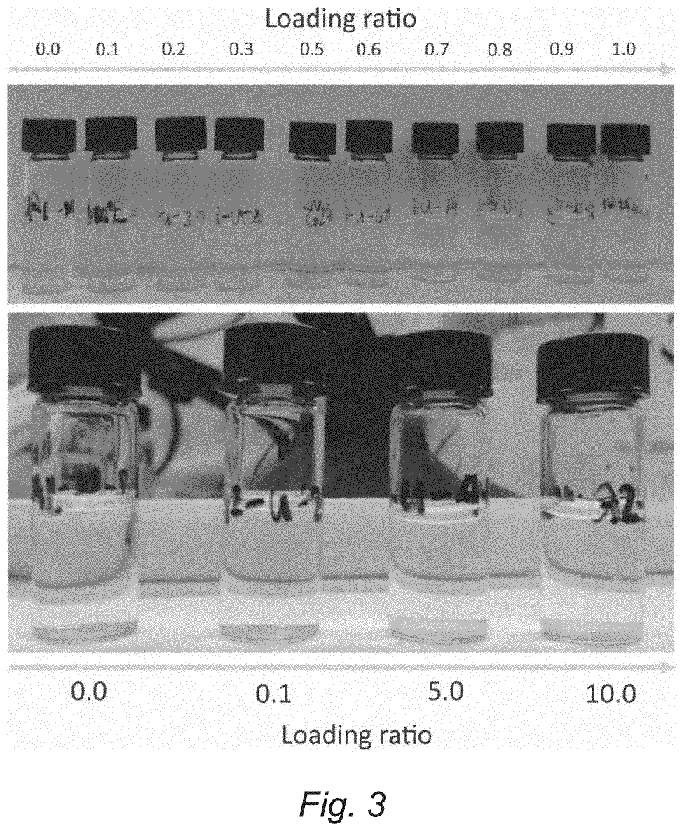

FIG. 3 shows exemplarily the precipitate formation dependent on the uranyl:dendrimer ratio for the extraction experiments with the G2 PAMAM dendrimer. For a ratio between 0:1-1:1 no precipitate formation was visible to the eye, but a yellow coloration of the solution became visible at a ratio of 0.5:1. For higher uranyl loadings with ratios of 5:1 and 10:1 a yellow precipitate formation was observed.

### 1.5 Fluorescence Analysis

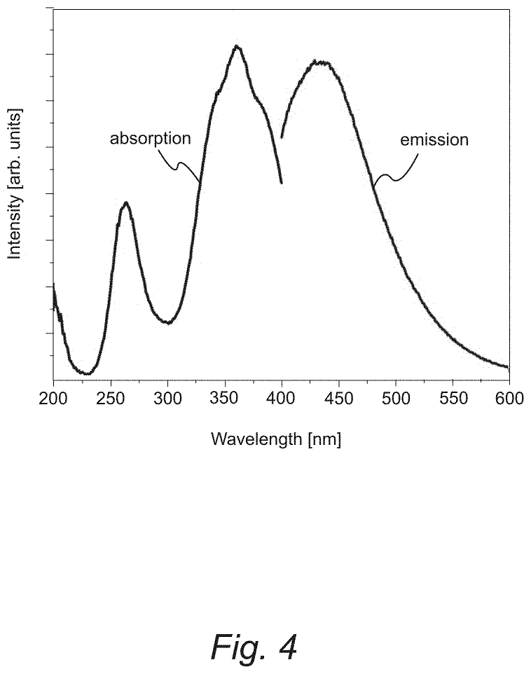

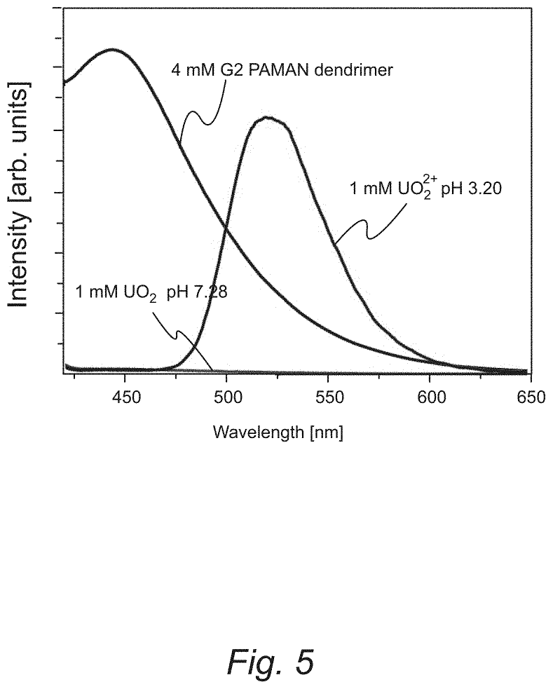

Due to the strong emission of the dendrimer, fluorescence spectroscopy can be a powerful tool to probe the potential complexation and molecular/ion interaction through fluorescence quenching, i.e. its spectral and intensity changes. Any nitrogen-branched dendrimer with triethylamine (TEA) in the backbone exhibits fluorescence.⁶¹ PAMAM reveals a strong excitation peak at 360 nm with emission centered at 450 nm (FIG. 4). Opposite, 360 nm excitation is on a side of broad absorption resonance for free uranyl ions, giving a small phosphorescence signal at 525 nm at neutral pH. (FIG. 5, orange curve). Thus, the emissions of the dendrimer and uranyl do not overlap, allowing the effective detection of both concentrations and to make in operando observations of complexation processes.

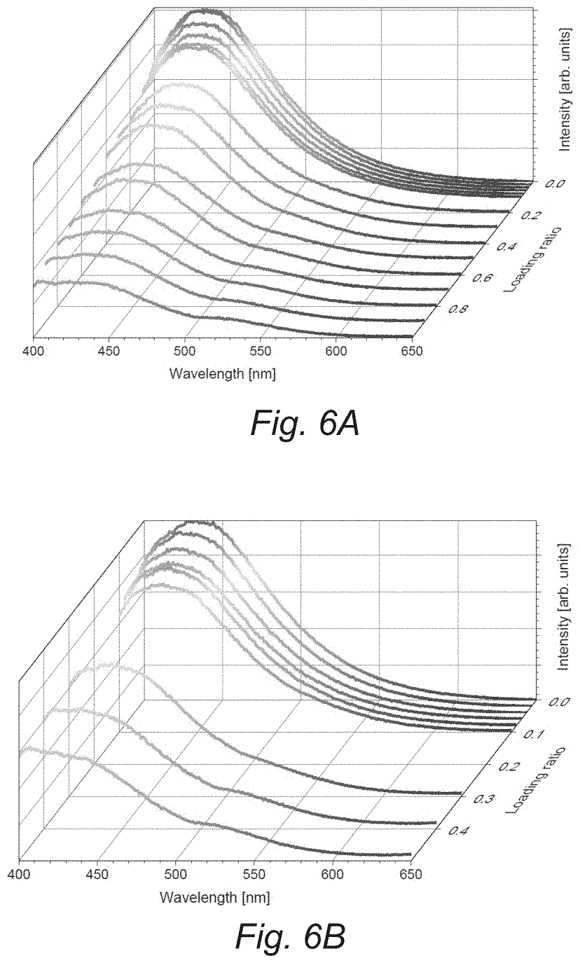

Both fluorescence quenching due to dendrimer/uranyl complexation and the decrease of molecular concentration through precipitation will influence the emission strength. FIG. 6 shows, that the increase of the molar ratio of uranyl ions vs. dendrimer molecules results in a significant decrease of the fluorescence intensity. It is important to note that this effect is gradual up to 1:1 molar concentration ratio. This indicates the effect is mainly related to fluorescence quenching.

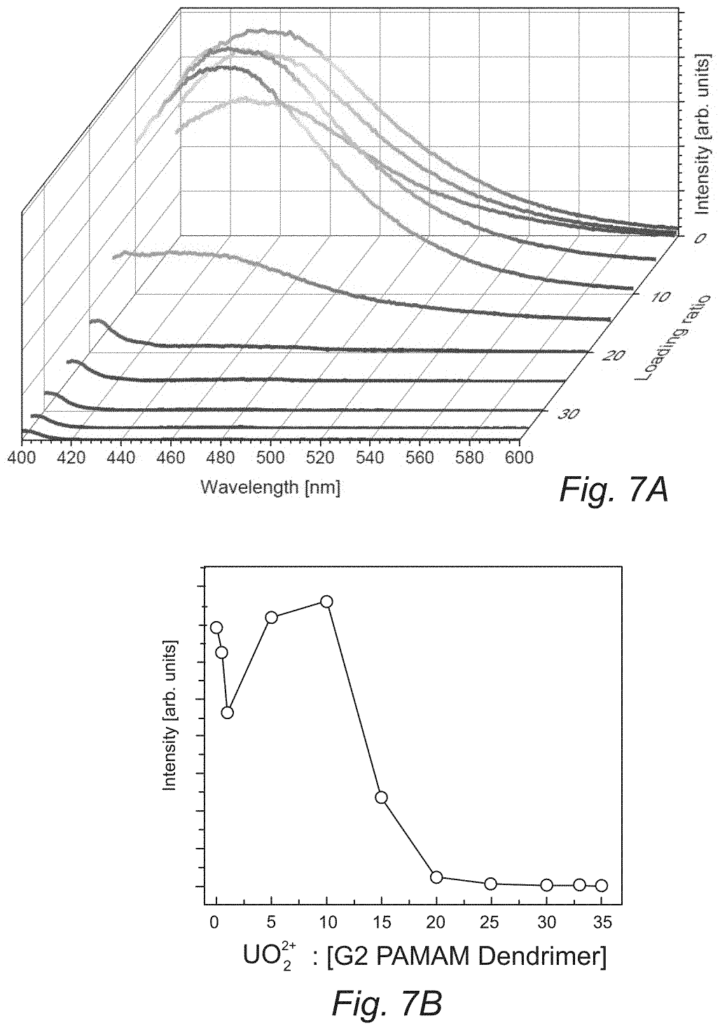

Opposite, if precipitation occurs, one can expect the emission signals to change drastically not only from the concentration decrease but also from an enhanced scattering of excitation and emission photons on a large number of particulates. Such chaotic signals appear at ratios exceeding 1:1 and are clearly observed in FIG. 7, bottom. Further increase of the uranyl ion concentration results in full precipitation of the PAMAM complexed uranyl—no fluorescence signals neither for the PAMAM dendrimer or the uranyl ions are observed in the bulk solution. Using this approach, one can make a rough estimate of the maximum uranyl ion loading obtained for generations G1-G3 (Table 1).

### 1.6 Neutron Activation Analysis

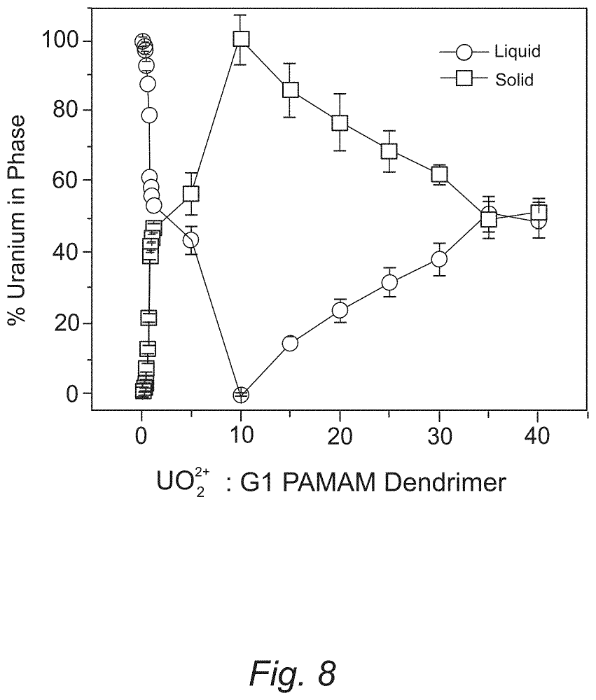

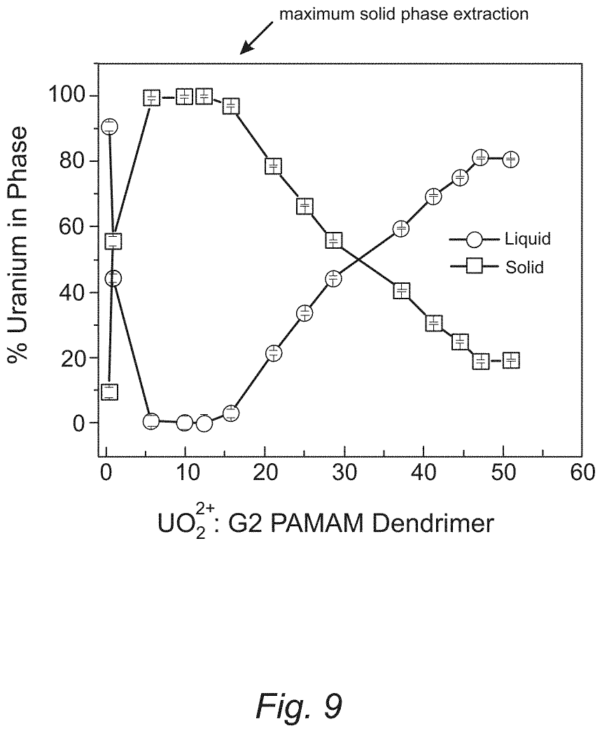

Neutron activation analysis (NAA) has been used as another approach to determine the uranium concentration both in the liquid and solid phase. As obvious from FIG. 8, even below a 1:1 molar ratio of U:dendrimer uranium precipitation is detectable, though not visible to the naked eye. For Generation 1, NAA shows close to 100% phase transformation already at a 1:1 molar concentration ratio. This agrees well with the fluorescence experiments, where the dependence deviates from a monotonical behavior around a similar concentration point. Further addition of uranyl ions results in an increase of the uranium presence in the liquid phase (FIG. 9) that most probably is associated with the saturation of the dendrimer molecule. The following allows to estimate the molecular “capacity” for each generation—see Table 1. Therefore, it is clear that scaling up of this type of separation should involve careful control of the molar ratio of uranium and the dendrimer to optimize the extraction into the solid phase.

TABLE 1
Uranyl ion loading on G1-G3 PAMAM dendrimers. The maximum metal
loading and retention capacity was determined experimentally
from fluorescence experiments and neutron activation analysis,
whereas the tertiary and primary amine numbers are the total
number of each functional group in the specified generation.

| | | | | Retention |
|---|---|---|---|---|
| | Molar Ratio at | Tertiary | Primary | Capacity |
| Dendrimer | Maximum Metal | (Interior) | (Terminal) | (g uranium/g |
| Generation | Loading | Amines | Amines | GX dendrimer) |
| G1 | 10 | 6 | 8 | 1.66 |
| G2 | 12-15 | 14 | 16 | 0.88-1.10 |
| G3 | 20-25 | 30 | 32 | 0.69-0.86 |

### 1.7 Conclusions

Dendrimers with nitrogen binding sites are selective for the uranyl ion. PAMAM dendrimers, as studied herein, have high metal ion loading capabilities for the uranyl ion, with G2 having the highest retention capacity of 0.88-1.10 g uranium per g of GX dendrimer.

Liquid-solid separations without a solid support are shown to be possible. In particular, complexation of the uranyl ions with an excess of metal ions can enhance supramolecular interactions and the structure/rigidity of the complex, causing precipitation, thus enabling a straightforward solid-liquid separation. Each PAMAM generation has a different binding capacity, allowing separation/filtration to be tailored for specific applications. Ideal separation efficiency (close to 100% separation) can be predicted through fine-tuning the uranyl to dendrimer ratio to optimize the economic utilization of the dendrimer as a complexing agent (cf. Table 1).

### 2. Lead Ion Separation

### 2.1 Example 1

About 0.729 mL of 20 wt % PAMAM are dried in methanol by allowing to evaporate in fume hood to obtain 0.1254 g dry dendrimer. About 6.38 mL of 0.1 M NaNO3 is added to obtain 6.38 mL of 0.00604 M PAMAM Solution. 5 mL of 0.12 M PbNO3 solution is made by taking 0.1997 g PbNO3 and filling to 5 mL with 0.1 M NaNO3. 0.12 M PbNO3 is diluted to 0.00604 M by combining 0.2768 mL 0.12 M PbNO3 with 5.2232 mL 0.1 M NaNO3. About 5.5 mL 0.00604 M PbNO3 are combined with 5.5 mL 0.00604 M PAMAM. A white precipitation occurs immediately upon combination at 12:15 PM 6/23/2021, following day approximately 3 PM was centrifuged at 4400 rpm for 5 minutes after taking second pH measurement.

### 2.2 Example 2

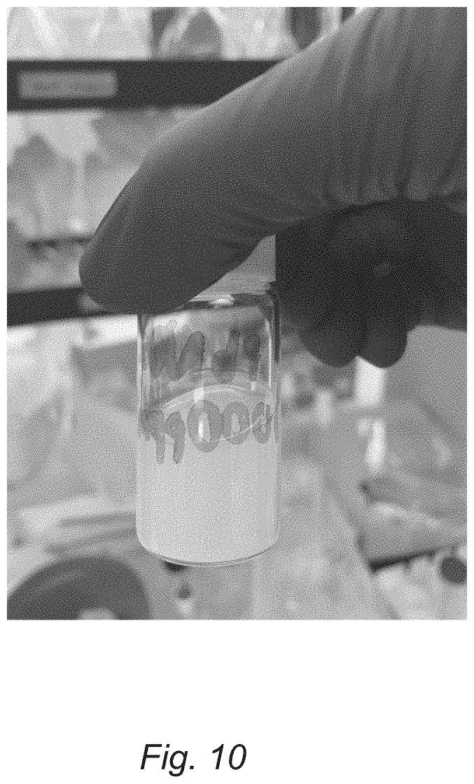

About 1.584 mL of 20 wt % PAMAM are dried in methanol by allowing to evaporate in fume hood to obtain 0.2725 g dry dendrimer. The dendrimer is combined with 13.5 mL of 0.1 M NaNO3 to get 13.5 mL 0.0062 M PAMAM solution. About 0.281 mL of 0.12 M PbNO3 solution is combined with 10.719 mL of 0.0062 M PAMAM Results: white precipitation occurred immediately upon combination at 12:10 PM 6/23/2021, following day approximately 3 PM was centrifuged at 4400 rpm for 5 minutes after taking second pH measurement. FIG. 10 provides a photograph showing the formed precipitate.

### 3. Neptunyl Ion Separation

### 3.1 Preparation

For neptunyl (V) samples, three stock solutions were similarly prepared: a 10 mM NpO₂NO₃ stock solution in 1 M sodium nitrate at a pH of 3, a 1 M sodium nitrate solution at a pH of 7-7.2 and a 4 mM GXdendrimer solution at a pH of 7-7.2. Various amounts of the three stock solutions were mixed such that each sample had a final concentration of 1 mM NpO₂₊, a molar equivalent of 0.0-1.0 GX PAMAM dendrimer:NpO²⁺ in increments of 0.1, and an overall ionic strength of 1 M sodium nitrate. The final pH was approximately 6.8-7.2.

Neptunyl (VI) was prepared by dissolving 240 μL of approximately 2 M NpNO₃ stock solution in 3 mL of 4 M HNO₃. The solution was heated to near dryness and redissolved in 3 mL of 4 M HNO₃. The heating and redissolution steps were repeated four times, then when the solution was evaporated to near dryness a fifth time, it was redissolved in 1 M sodium nitrate for a final concentration of 12 mM Np(NO₃)₂. The solution was adjusted to a pH of 3 by bubbling ammonium nitrate through the solution. A 1 M sodium nitrate stock solution was prepared in the standard manner. A 20 mM GXPAMAM dendrimer solution in 1 M sodium nitrate was also prepared. The concentration of neptunyl (VI) and dendrimer in the prepared samples was slightly higher compared to samples with other metal ions due to the fact that the molar absorptivity coefficient of Np (VI) is low and a standard 1 cm plastic cuvette was used to better measure the absorption and potential precipitation over time (flow cells can have unstable signal or air bubbles develop in stagnant samples). Seven samples were created with a concentration of 4.5 mM Np(NO₃)₂, a molar ratio of 0, 0.1, 0.3, 0.5, 0.7, 0.9 or 1 GX PAMAM Dendrimer: Np(NO₃)₂, and an overall ionic strength of 1 M sodium nitrate. The final pH was approximately 6.8-7.2, though the pH varied over time as Np(VI) was reduced to Np(V).

### 3.2 Neptunyl-PAMAM Dendrimer Complexes

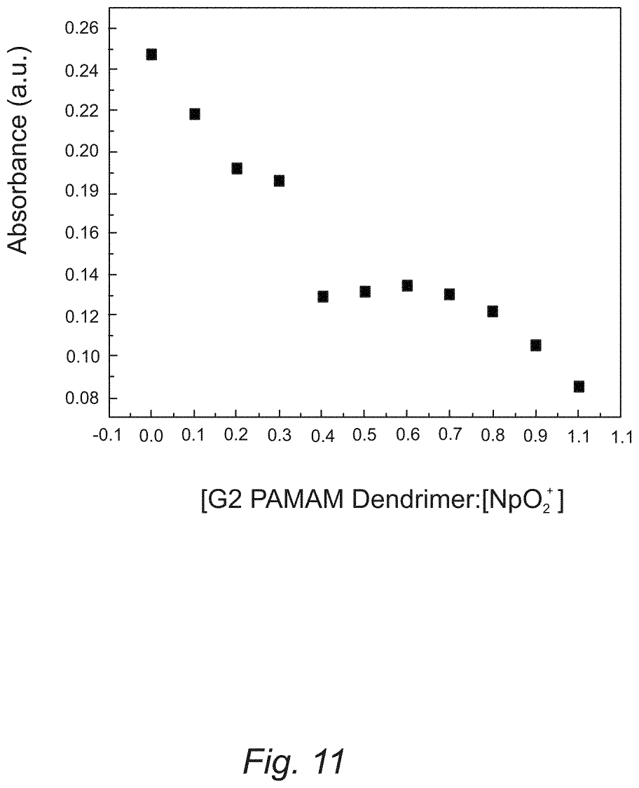

For UV-Visible experiments, the absorbance of the metal ion is measured when titrated with the GXPAMAM dendrimer to directly monitor the change in the metal ion when complexed with the dendrimer. Due to the radioactive nature of neptunium, fluorescence spectroscopy in a shared facility was also not feasible at the time of experimentation. Regardless, a clear difference was seen when even small molar equivalents of dendrimer were present in the neptunyl solution. Without dendrimer present, addition of the NpO₂ to a solution of 1 M NaNO3 at a pH of 7 turned the green-blue neptunyl stock into a slightly brown solution. The brown color is characteristic of NpO₂₊ speciation in a neutral to alkaline solution, whereas the ion normally forms a blue-green solution in acidic conditions. FIG. 11 provides the NIR absorbance as a function of [G2 PAMAM Dendrimer]:[NpO₂₊] ratio.

Analysis of the liquid phase in the NIR region reveals that the absorbance signal of the NpO₂₊ at approximately 980 nm, proportional to the concentration, decreases with no introduction of a red-shifted or blue-shifted complexation peak. This is expected, as it is likely that a majority of the neptunyl that has been removed has been separated into the solid phase. There is an unusual discontinuity between a ratio of 0.3 to 0.4, followed by a plateau until about a ratio of 0.7. The data points above and below this point with the exclusion of 0.4-0.6 are mainly linear.

This transitional period of nonlinear signal is likely where precipitate begins to form in appreciable quantities. The discontinuity could represent the solid precipitating immediately after some critical concentration is reached. Following that, addition of more dendrimer could simply aggregate with the bulk solid until some concentration is reached (at about a ratio of 0.6) when additional dendrimer molecules with available binding sites begin complexing the neptunyl ion once again.

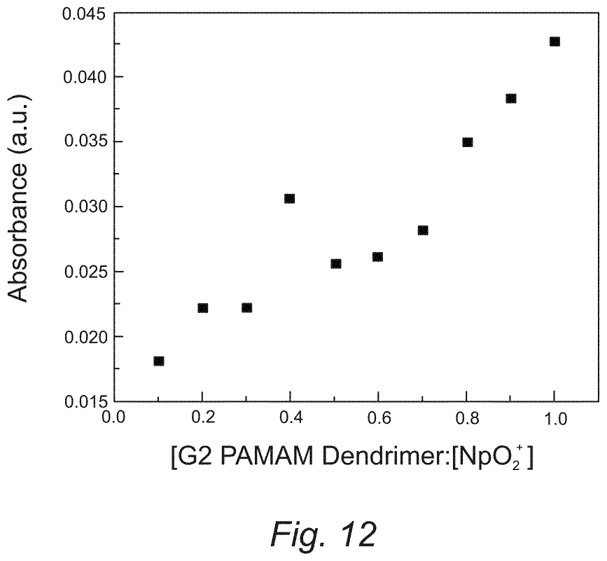

Measurements of the solid phase, redissolved into 0.01 M nitric acid, confirms separation of some quantity of the neptunyl into a solid phase, with irregular signal (FIG. 12). Spectra were corrected for the relative absorbance increase due to the difference in pH using two NpO₂₊ standards in the more acidic and less acidic conditions.

The concentration of NpO₂₊ does increase with higher relative concentration of the G2 PAMAM dendrimer added, with the exception of the sample with the 0.4 molar ratio. This could possibly be an outlier but the experiment was not repeated due to the scarcity of the neptunium and the conclusions that can be drawn regardless of this outlier. The rapid decrease in neptunyl concentration at this molar ratio followed by a plateau in the liquid phase indicates this may be an interesting and important point to keep in as a transitional point in the complexation chemistry from the liquid to the solid phase.

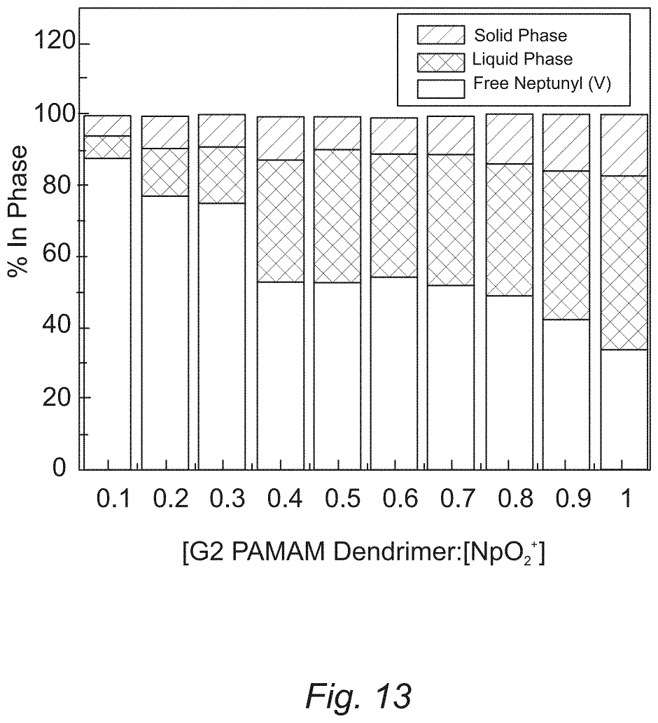

Overall, although the concentration in the solid phase (cₛ) does increase, relative to the theoretical total concentration (cₜₒₜ), it is still a small percentage compared to the non-complexed neptunyl in the liquid phase (c_{free}), as well as the neptunyl that has been calculated to be complexed in the liquid phase (cₗ) (FIG. 13):

ctot=cfree+cl+cs

cl=cfree+ctot+cs

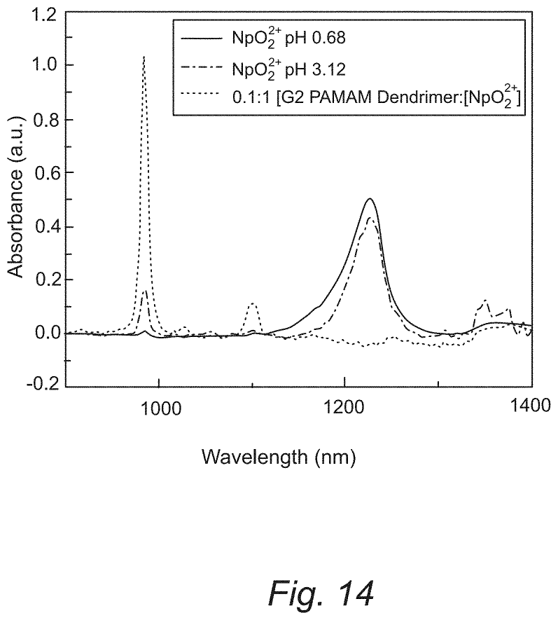

The experiment was repeated similarly with NpO₂₂₊, also known as neptunyl (VI). Although this has a similar structure as neptunyl (V) and uranyl (VI), it has the same oxidation state and subsequently the same charge as the uranyl (VI) ion, UO₂₂₊. With addition of a small (0.1:1 [G2 PAMAM dendrimer]:[NpO₂₂₊]) amount of dendrimer, a large portion of the neptunyl (VI) was instantaneously reduced to neptunyl (V). It also significantly blue-shifts the neptunyl (VI) from about 1226 nm to 1100 nm (FIG. 14). This could be evidence of complexation in the liquid phase that is less stable (higher energy complex) than the ground state of neptunium alone. This could be consistent with either of two NIR peaks (1080 and 1120 nm) that have previously reported with neptunyl dinitrate complexes in highly (4 M HNO₃) acidic media, resulting from two nitrate ions replacing water molecules in the inner coordination sphere.₁₁₈ At a neutral pH such as the experiments completed in this work and with the addition of an N-donor ligand, there is equal likelihood that the Np-N bond could be between neptunyl (VI) and a nitrate ion or an amine-based nitrogen from the PAMAM dendrimer.

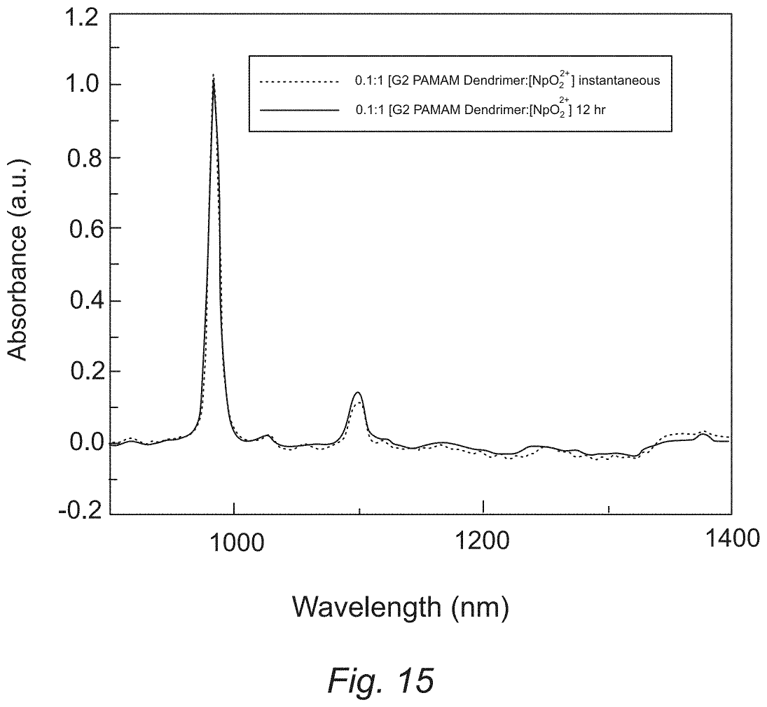

Most likely, this is due to the neutral pH conditions and not necessarily due to the presence of the G2 PAMAM dendrimer beyond the fact that the G2 PAMAM dendrimer tends to hold the pH at a relatively constant value due to its numerous amine sites, which can be protonated or deprotonated. The absorbance remains stable, with only a slight increase in the 1100 nm peak when measured the next day (FIG. 15).

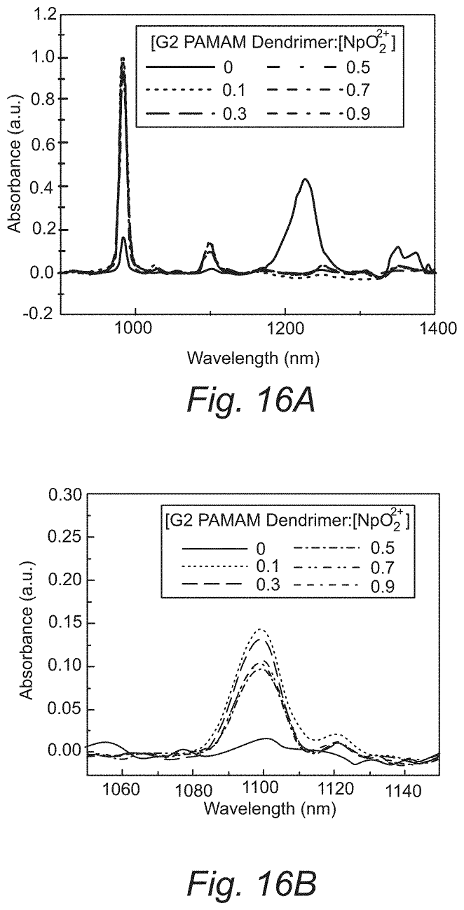

This indicates that the dendrimer can effectively stabilize some portion of the neptunyl in the Np(VI) state, whereas without the dendrimer, Np(VI) will typically reduce within several hours in solutions that are not highly acidic. This pattern remains consistent through several samples with varying concentrations of G2 PAMAM dendrimer, varying only in a slight variation in the absorbance of 1100 nm peak (FIG. 16).

At a molar ratio of 1:1 [G2 PAMAM Dendrimer]:[NpO₂₂₊], the solution looks significantly different from the preceding samples and when left to equilibrate, a brown precipitate forms, a characteristic color of neptunyl (VI) solids.

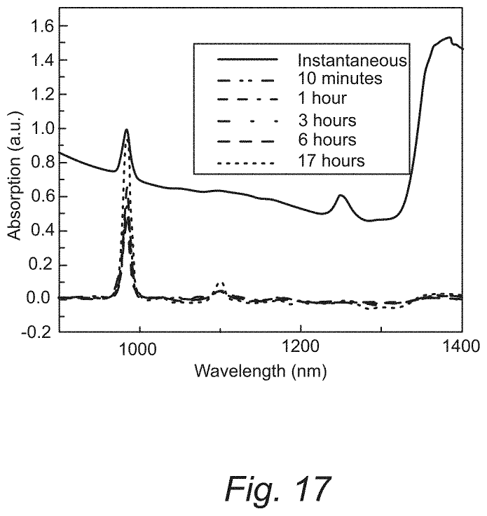

Evidence of precipitate formation can be seen in a very high baseline when the G2 PAMAM dendrimer was added, however, this stabilized within 10 minutes. After leaving the sample in a cuvette overnight, the precipitate settled to the bottom and the supernatant was measured (FIG. 17).

Interestingly, it appears that over time the characteristic neptunyl (V) peak at 980 nm begins to increase. The molar absorptivity of neptunyl (V) is nearly ten times higher than that of neptunyl (VI), so this could be a result of the neptunyl (VI) reducing over several hours. However, when compared with a sample with a lower concentration of dendrimer, the spectrum looks nearly the same measured immediately after the precipitate and measured the following day. This means there is some intermediate step that the 1:1 sample is undergoing that the other samples do not. Because there are more dendrimer molecules in this sample, more interaction and precipitate forms initially (at about 10 minutes). However, over time as the neptunyl (VI) reduces, it appears to have a lower affinity for the neptunyl (V) ion increases over time, indicating some of the complexed NpO₂₂₊-G2 PAMAM dendrimer complexes equilibrate back into the liquid phase. It appears the dendrimer is more stable with divalent cations than monovalent cations.

In summary, although neptunyl in the +5 and the +6 oxidation state appears to complex and partially precipitate, the precipitation percentage is low compared to uranium and it mostly remains either as a non-complexed ion or in a liquid-phase complex. The one noticeable exception is NpO₂₂₊, which at a ratio of 1:1 [G2 PAMAM Dendrimer]:[NpO₂₂₊] has a significantly observable precipitate especially compared to the other samples at lower ratios. This appears to be because the absolute concentration of neptunyl (VI) was ten times higher in comparison to the neptunyl (V) and uranyl (VI) samples to obtain a better NIR signal with a lower molar absorptivity. In addition, this may indicate a slightly higher affinity for a +2 cation, such as uranyl (VI) and neptunyl (VI). Both NpO₂₊ and NpO₂₂₊ appear to have rapid precipitate transitions, though the NpO₂₊ transition is both unstable, inconsistent following the transition, and most importantly does not appear to cause significant precipitation at a concentration of 1 mM. Although this research could use more in-depth analysis in certain areas, these results indicate that PAMAM dendrimers can coordinate neptunium to cause bulk precipitation of the actinyls, including the potential for plutonyl precipitation if the plutonium is oxidized to the hexavalent state. This would be highly useful for generation of MOX fuel, although the amount of neptunyl precipitated must be carefully controlled to avoid a positive void coefficient during reactor operation.₁₁₉ In addition, the high variability of precipitation observed in the neptunyl and uranyl studies indicate the oxidation state of the actinyl, the absolute concentration of the and releases it into solution as a free ion, leading to increased absorbance in the characteristic 980 nm region. The peak at 1100 nm also metal ion, and the pH of solutions can be manipulated to selectively precipitate some actinyls or potentially hold some metal ions back in the liquid phase while other actinyls are extracted, depending on the conditions.

### 3.3 Conclusions

UV-Vis-NIR confirmed that neptunyl (V) and (VI) both formed complexes with PAMAM dendrimers, also resulting in the formation of precipitate. This indicates part of the affinity for these types of elements is due to their dioxocation structural (AnO₂₊/AnO₂₂₊), and suggests plutonyl should follow similar binding behavior. The PAMAM dendrimers appear to have a slightly higher affinity for the AnO₂₂₊ (hexavalent U(VI) and Np(VI) ions versus the AnO₂₊ (pentavalent Np(V)) ions, which is expected because the hexavalent actinyl ions are expected to act similarly in solution.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.
(1) Grenthe, I.; Drozdzynski, J.; Takeo, F.; Buck, E. C.; Albrecht-Schmitt, T. E.; Wolf, S. F. Uranium. In The Chemistry of the Actinide and Transactinide Elements; Morss, L. R., Edelstein, N. M., Fuger, J., Eds.; Springer International Publishing: Dordrecht, The Netherlands, 2006; Vol. 1, pp 253-698.
(2) Royal Society of Chemistry. Uranium https://www.rsc.org/periodictable/element/92/uranium#:˜:text=Uranium is also used by ships and counterweights for aircraft.
(3) Rodman, M. R.; Gordon, L. I.; Chen, A. C. T. Extraction of Uranium from Seawater: Evaluation of Uranium Resources and Plant Sitting; 1979; Vol. 2. https://doi.org/10.1017/CBO9781107415324.004.
(4) Rao, L. Recent International R & D Activities in the Extraction of Uranium from Seawater; 2011.
(5) Abney, C. W.; Mayes, R. T.; Saito, T.; Dai, S. Materials for the Recovery of Uranium from Seawater. Chem. Rev. 2017, 117 (23), 13935-14013. https://doi.org/10.1021/acs.chemrev.7b00355.
(6) Kim, J.; Tsouris, C.; Mayes, R. T.; Oyola, Y.; Saito, T.; Janke, C. J.; Dai, S.; Schneider, E.; Sachde, D. Recovery of Uranium from Seawater: A Review of Current Status and Future Research Needs. Sep. Sci. Technol. 2013, 48 (3), 367-387. https://doi.org/10.1080/01496395.2012.712599.
(7) Guo, X.; Gin, S.; Lei, P.; Yao, T.; Liu, H.; Schreiber, D. K.; Ngo, D.; Viswanathan, G.; Li, T.; Kim, S. H.; Vienna, J. D.; Ryan, J. V.; Du, J.; Lian, J.; Frankel, G. S. Self-Accelerated Corrosion of Nuclear Waste Forms at Material Interfaces. Nat. Mater. 2020, 19 (March). https://doi.org/10.1038/s41563-019-0579-x.
(8) Burns, W. G.; Hughes, A. E.; Marples, J. A. C.; Nelson, R. S.; Stoneham, A. M. Effects of Radiation on the Leach Rates of Vitrified Radioactive Waste. J. Nucl. Mater. 1982, 107 (2-3), 245-270. https://doi.org/10.1016/0022-3115(82)90424-X.
(9) Chloride-Induced Stress Corrosion Cracking Potential In Dry-Storage Canisters For Spent Nuclear Fuel; 2017.
(10) Li, J.; Zhang, Y. Remediation Technology for the Uranium Contaminated Environment: A Review. Procedia Environ. Sci. 2012, 13 (2011), 1609-1615. https://doi.org/10.1016/j.proenv.2012.01.153.
(11) Lunt, D.; Boshoff, P.; Boylett, M.; El-Ansary, Z. Uranium Extraction: The Key Process Drivers. J. South. African Inst. Min. Metall. 2007, 107 (7), 419-426.
(12) World Nuclear Organization. Uranium Mining Overview https://www.worldnuclear. org/information-library/nuclear-fuel-cycle/mining-of-uranium/uranium-miningoverview. aspx.
(13) Seidel, D. Extracting Uranium from Its Ores. IAEA Publ. 1980, 23 (2), 24-26.
(14) Starks, J. B. The Purex Process; 1997. (15) Zabunoglu, O. H.; Ozdemir, L. Purex Co-Processing of Spent LWR Fuels: Flow Sheet. Ann. Nucl. Energy 2005, 32 (2), 151-162. https://doi.org/10.1016/j.anucene.2004.07.015.
(16) Herbst, R. S.; Baron, P.; Nilsson, M. Standard and Advanced Separation: PUREX Processes for Nuclear Fuel Reprocessing; Woodhead Publishing Limited, 2011. https://doi.org/10.1533/9780857092274.2.141.
(17) Council, N. R. Proliferation Risk in Nuclear Fuel Cycles: Workshop Summary; The National Academies Press.: Washington, D.C., 2011.
(18) Kumar, J. R.; Kim, J. S.; Lee, J. Y.; Yoon, H. S. A Brief Review on Solvent Extraction of Uranium from Acidic Solutions. Sep. Purif. Rev. 2011, 40 (2), 77-125. https://doi.org/10.1080/15422119.2010.549760.
(19) Veliscek-Carolan, J. Separation of Actinides from Spent Nuclear Fuel: A Review. J. Hazard. Mater. 2016, 318, 266-281.
(20) Jenkins, I. L. Solvent Extraction Chemistry in the Atomic Energy Industry—A Review. Hydrometallurgy 1979, 4, 1-20.
(21) Aly, M. M.; Hamza, M. F. A Review: Studies on Uranium Removal Using Different Techniques. Overview. J. Dispers. Sci. Technol. 2013, 34 (2), 182-213. https://doi.org/10.1080/01932691.2012.657954.
(22) Manna, D.; Ghanty, T. K. Complexation Behavior of Trivalent Actinides and Lanthanides with 1,10-Phenanthroline-2,9-Dicarboxylic Acid Based Ligands: Insight from Density Functional Theory. Phys. Chem. Chem. Phys. 2012, 14 (31), 11060-11069. https://doi.org/10.1039/c2cp40083a.
(23) Nash, K. L., Lumetta, G. L., Vienna, J. D. Irradiated Nuclear Fuel Management: Resource versus Waste. In Radioactive Waste Management and Contaminated Site Clean-Up: Processes, Technologies and International Experience; Woodhead Publishing Limited: Cambridge, UK, 2013; pp 171-272. https://doi.org/10.1533/9780857097446.1.171.
(24) Cotton, S. Lanthanide and Actinide Chemistry; 2006. https://doi.org/10.1002/0470010088.
(25) Gill, M.; Livens, F.; Peakman, A. Nuclear Fission. In Future Energy: Improved, Sustainable and Clean Options for our Planet; 2013. https://doi.org/10.1016/B978-0-08-099424-6.00009-0.
(26) Lovasic, Z. Spent Fuel Reprocessing Options, IAEA-TECDOC-1587. Nucl. Fuel Cycle Mater. Sect. 2008, No. August, 151.
(27) Taylor, R. Reprocessing and Recycling of Spent Nuclear Fuel; Woodhead Publishing Limited: Cambridge, UK, 2015. https://doi.org/10.1016/C2013-0-16483-5.
(28) Tsouris, C. Uranium Extraction: Fuel from Seawater. Nat. Energy 2017, 2 (4), 2-4. https://doi.org/10.1038/nenergy.2017.22.
(29) Rao, T. P.; Metilda, P.; Gladis, J. M. Preconcentration Techniques for Uranium(VI) and Thorium(IV) Prior to Analytical Determination-an Overview. Talanta 2006, 68 (4), 1047-1064. https://doi.org/10.1016/j.talanta.2005.07.021.
(30) Ansari, S. A.; Mohapatra, P. K. A Review on Solid Phase Extraction of Actinides and Lanthanides with Amide Based Extractants. J. Chromatogr. A 2017, 1499, 1-20. https://doi.org/10.1016/j.chroma.2017.03.035.
(31) Rosenberg, E.; Pinson, G.; Tsosie, R.; Tutu, H.; Cukrowska, E. Uranium Remediation by Ion Exchange and Sorption Methods: A Critical Review. Johnson Matthey Technol. Rev. 2016, 60 (1), 59-77. https://doi.org/10.1595/205651316X690178.
(32) Diallo, M. S.; Christie, S.; Swaminathan, P.; Balogh, L.; Shi, X.; Um, W.; Papelis, C.; Goddard, W. A.; Johnson, J. H. Dendritic Chelating Agents. 1. Cu(II) Binding to Ethylene Diamine Core Poly(Amidoamine) Dendrimers in Aqueous Solutions. Langmuir 2004, 20 (7), 2640-2651. https://doi.org/10.1021/1a036108k.
(33) Alivertis, D.; Paraskevopoulos, G.; Theodorou, V.; Skobridis, K. Dendritic Effects of Crown Ether-Functionalized Dendrimers on the Solvent Extraction of Metal Ions. Tetrahedron Lett. 2009, 50 (44), 6019-6021. https://doi.org/10.1016/j.tetlet.2009.08.053.
(34) Tomalia, D. A. Dendritic Effects: Dependency of Dendritic Nano-Periodic Property Patterns on Critical Nanoscale Design Parameters (CNDPs). New J. Chem. 2012, 36 (2), 264-281. https://doi.org/10.1039/c1nj20501c.
(35) Chow, H. F.; Leung, C. F.; Wang, G. X.; Yang, Y. Y. Dendritic Effects in Functional Dendrimer Molecules. Comptes Rendus Chim. 2003, 6 (8-10), 735-745. https://doi.org/10.1016/j.crci.2003.07.001.
(36) Castillo, V. A.; Barakat, M. A.; Ramadan, M. H.; Woodcock, H. L.; Kuhn, J. N. Metal Ion Remediation by Polyamidoamine Dendrimers: A Comparison of Metal Ion, Oxidation State, and Titania Immobilization. Int. J. Environ. Sci. Technol. 2014, 11 (6), 1497-1502. https://doi.org/10.1007/s13762-013-0346-5.
(37) Vunain, E.; Mishra, A. K.; Mamba, B. B. Dendrimers, Mesoporous Silicas and Chitosan-Based Nanosorbents for the Removal of Heavy-Metal Ions: A Review. Int. J. Biol. Macromol. 2016, 86, 570-586. https://doi.org/10.1016/j.ijbiomac.2016.02.005.
(38) Sadjadi, S.; Sadjadi, S. 13—Dendritic Polymers for Environmental Remediation; Hussain, C. M., Mishra, A. K. B. T.-N. P. N. for E. R., Eds.; Elsevier, 2018; pp 279-335. https://doi.org/https://doi.org/10.1016/B978-0-12-811033-1.00013-5.
(39) Mohseni, M.; Akbari, S.; Pajootan, E.; Mazaheri, F. Amine-Terminated Dendritic Polymers as a Multifunctional Chelating Agent for Heavy Metal Ion Removals. Environ. Sci. Pollut. Res. Int. 2019, 26 (13), 12689-12697. https://doi.org/10.1007/s11356-019-04765-3.
(40) Sajid, M. Dendrimers Based Sorbents: Promising Materials for Analytical Extractions. TrAC Trends Anal. Chem. 2018, 98, 114-127. https://doi.org/https://doi.org/10.1016/j.trac.2007.11.005.
(41) Huang, Y.; Feng, X. Polymer-Enhanced Ultrafiltration: Fundamentals, Applications and Recent Developments. J. Memb. Sci. 2019, 586, 53-83. https://doi.org/https://doi.org/10.1016/j.memsci.2019.05.037.
(42) Priyadarshini, N.; Benadict Rakesh, K.; Ilaiyaraja, P. Actinide Speciation in Environment and Their Separation Using Functionalized Nanomaterials and Nanocomposites. In Handbook of Environmental Materials Management; 2018.
(43) Diallo, M. S.; Arasho, W.; Johnson, J. H.; Goddard III, W. A. Dendritic Chelating Agents. 2. U(VI) Binding to Poly(Amidoamine) and Poly(Propyleneimine) Dendrimers in Aqueous Solutions. Environ. Sci. Technol. 2008, 42 (5), 1572-1579. https://doi.org/10.1021/es0715905.
(44) Zhang, Q.; Wang, N.; Zhao, L.; Xu, T.; Cheng, Y. Polyamidoamine Dendronized Hollow Fiber Membranes in the Recovery of Heavy Metal Ions. ACS Appl. Mater. Interfaces 2013, 5 (6), 1907-1912. https://doi.org/10.1021/am400155b.
(45) Grüttner, C.; Bohmer, V.; Casnati, A.; Dozol, J.-F.; Reinhoudt, D. N.; Reinoso-Garcia, M. M.; Rudershausen, S.; Teller, J.; Ungaro, R.; Verboom, W.; Wang, P. Dendrimer-Coated Magnetic Particles for Radionuclide Separation. J. Magn. Magn. Mater. 2005, 293 (1), 559-566. https://doi.org/https://doi.org/10.1016/j.jmmm.2005.01.073.
(46) Yuan, D.; Chen, L.; Xiong, X.; Zhang, Q.; Liao, S.; Yuan, L.; Wang, Y. Synthesis of PAMAM Dendron Functionalized Superparamagnetic Polymer Microspheres for Highly Efficient Sorption of Uranium(VI). J. Radioanal. Nucl. Chem. 2016, 309 (3), 1227-1240. https://doi.org/10.1007/s10967-016-4735-3.
(47) Cao, Q.; Liu, Y.; Wang, C.; Cheng, J. Phosphorus-Modified Poly(Styrene-Co-Divinylbenzene)-PAMAM Chelating Resin for the Adsorption of Uranium(VI) in Aqueous. J. Hazard. Mater. 2013, 263, 311-321. https://doi.org/10.1016/j.jhazmat.2013.05.039.
(48) Ilaiyaraja, P.; Deb, A. K. S.; Ponraju, D.; Ali, S. M.; Venkatraman, B. Surface Engineering of PAMAM-SDB Chelating Resin with Diglycolamic Acid (DGA) Functional Group for Efficient Sorption of U(VI) and Th(IV) from Aqueous Medium. J. Hazard. Mater. 2017, 328, 1-11. https://doi.org/https://doi.org/10.1016/j.jhazmat.2017.01.001.
(49) Priyadarshini, N.; Ilaiyaraja, P. Adsorption of U(VI) and Th(IV) from Simulated Nuclear Waste Using PAMAM and DGA Functionalized PAMAM Dendron Grafted Styrene Divinylbenzene Chelating Resins. Chem. Pap. 2019, 73 (11), 2879-2884. https://doi.org/10.1007/s11696-019-00830-w.
(50) Ilaiyaraja, P.; Singha Deb, A. K.; Sivasubramanian, K.; Ponraju, D.; Venkatraman, B. Adsorption of Uranium from Aqueous Solution by PAMAM Dendron Functionalized Styrene Divinylbenzene. J. Hazard. Mater. 2013, 250-251, 155-166. https://doi.org/https://doi.org/10.1016/j.jhazmat.2013.01.040.
(51) Cong, H.; Zhou, L.; Meng, Q.; Zhang, Y.; Yu, B.; Shen, Y.; Hu, H. Preparation and Evaluation of PAMAM Dendrimer-Based Polymer Gels Physically Crosslinked by Hydrogen Bonding. Biomater. Sci. 2019, 7 (9), 3918-3925. https://doi.org/10.1039/c9bm00960d.
(52) Shaaban, A. F.; Khalil, A. A.; Lasheen, T. A.; Nouh, E. S. A.; Ammar, H. Polyamidoamine Dendrimers Modified Silica Gel for Uranium(VI) Removal from Aqueous Solution Using Batch and Fixed-Bed Column Methods. Desalin. Water Treat. 2018, 102 (January 2008), 197-210. https://doi.org/10.5004/dwt.2018.21813.
(53) Ansari, S. A.; Mohapatra, P. K.; Leoncini, A.; Huskens, J.; Verboom, W. Diglycolamide-Functionalized Dendrimers: Studies on Americium(III) Pertraction from Radioactive Waste. Sep. Purif. Technol. 2017, 187, 110-117. https://doi.org/10.1016/j.seppur.2017.06.028.
(54) Ottaviani, M. F.; Favuzza, P.; Bigazzi, M.; Turro, N. J.; Jockusch, S.; Tomalia, D. A. A TEM and EPR Investigation of the Competitive Binding of Uranyl Ions to Starburst Dendrimers and Liposomes: Potential Use of Dendrimers as Uranyl Ion Sponges. Langmuir 2000, No. 12, 7368-7372. https://doi.org/10.1021/1a000355w.
(55) Appelhans, D.; Oertel, U.; Mazzeo, R.; Komber, H.; Hoffmann, J.; Weidner, S.; Brutschy, B.; Voit, B.; Ottaviani, M. F. Dense-Shell Glycodendrimers: UV/Vis and Electron Paramagnetic Resonance Study of Metal Ion Complexation. Proc. R. Soc. A Math. Phys. Eng. Sci. 2010, 466 (2117), 1489-1513. https://doi.org/10.1098/rspa.2009.0107.
(56) Likos, C. N.; Lowen, H.; Watzlawek, M.; Abbas, B.; Jucknischke, O.; Allgaier, J.; Richter, D. Star Polymers Viewed as Ultrasoft Colloidal Particles. Phys. Rev. Lett. 1998, 80 (20), 4450-4453. https://doi.org/10.1103/PhysRevLett.80.4450.
(57) Rathgeber, S.; Monkenbusch, M.; Kreitschmann, M.; Urban, V.; Brulet, A. Dynamics of Star-Burst Dendrimers in Solution in Relation to Their Structural Properties. J. Chem. Phys. 2002, 117 (8), 4047-4062. https://doi.org/10.1063/1.1493771.
(58) Stellbrink, J.; Allgaier, J.; Monkenbusch, M.; Lang, A.; Lang, A.; Watzlawek, M.; Lowen, H.; Ehlers, G.; Schleger, P. Neither Gaussian Chains nor Hard Spheres—Star Polymers Seen as Ultrasoft Colloids. Prog. Colloid Polym. Sci. 2000, 115, 88-92. https://doi.org/10.1007/3-540-46545-6_18.
(59) Carbone, P.; Müller-Plathe, F. Molecular Dynamics Simulations of Polyaminoamide (PAMAM) Dendrimer Aggregates: Molecular Shape, Hydrogen Bonds and Local Dynamics. Soft Matter 2009, 5 (13), 2638-2647. https://doi.org/10.1039/b820908a.
(60) Blasini, D. R.; Flores-Torres, S.; Smilgies, D. M.; Abruna, H. D. Stepwise Self-Assembly of Ordered Supramolecular Assemblies Based on Coordination Chemistry. Langmuir 2006, 22 (5), 2082-2089. https://doi.org/10.1021/la052558w.
(61) Chu, C. C.; Imae, T. Fluorescence Investigations of Oxygen-Doped Simple Amine Compared with Fluorescent PAMAM Dendrimer. Macromol. Rapid Commun. 2009, 30 (2), 89-93. https://doi.org/10.1002/marc.200800571.

What is claimed is:

1. A method for separating metal ions from a liquid, the method comprising:
providing a solution having metal-containing ions and associated negative counterions;
contacting the metal-containing ions with a dendrimer to form solid particles of metal-containing ion-dendrimer complexes; and
separating the solid particles of metal-containing ion-dendrimer complexes from the solution.

2. The method of claim 1, wherein metal-containing ion-dendrimer complexes precipitate from the solution.

3. The method of claim 2, a molar ratio of metal ions to dendrimer is greater than 0.2.

4. The method of claim 2, a precipitate has an average particle size greater than 0.1 microns.

5. The method of claim 1 further comprising recovering a metal or metal-containing compounds from the solid particles of metal-containing ion-dendrimer complexes.

6. The method of claim 1 wherein the dendrimer is composed of a branched carbon-chain scaffold with functional groups at regular intervals.

7. The method of claim 1 wherein the dendrimer is composed of a C₂₋₂₀ alkyl-diamine core and amidoamine repeating branches.

8. The method of claim 7 wherein the C₂₋₂₀ alkyl-diamine core is selected from the group consisting of ethylenediamine, 1,2-diaminododecane, 1,4-diaminobutane, cystamine, 1,6-diaminohexane, and combinations thereof.

9. The method of claim 1 wherein the dendrimer is composed of a PAMAM.

10. The method of claim 1 wherein the dendrimer is a PAMAM dendrimer selected from the group consisting of PAMAM generation 1 dendrimers, PAMAM generation 2 dendrimers, PAMAM generation 3 dendrimers, PAMAM generation 4 dendrimers, PAMAM generation 5 dendrimers, PAMAM generation 6 dendrimers, PAMAM generation 7 dendrimers, PAMAM generation 8 dendrimers, PAMAM generation 9 dendrimers, and PAMAM generation 10 dendrimers, and combinations thereof.

11. The method of claim 1 wherein the dendrimer is a PAMAM dendrimer selected from the group consisting of PAMAM generation 2 dendrimers, and PAMAM generation 3 dendrimers.

12. The method of claim 1 wherein the dendrimer is a PAMAM generation 2 dendrimer.

13. The method of claim 1 wherein the metal-containing ions include a metal selected from the group consisting of alkali metals, alkaline earth metals, transition metals, lanthanides, actinides, and combinations thereof.

14. The method of claim 1 wherein the metal-containing ions are actinyl ions.

15. The method of claim 14 wherein the actinyl ions are selected from the group consisting of UO₂²⁺, NpO₂^{2+,} PuO₂²⁺, AmO₂²⁺ and combinations thereof.

16. The method of claim 14 wherein the actinyl ions are UO₂²⁺.

17. The method of claim 1 wherein the metal-containing ions are lead ions, cadmium ions, copper ions, nickel ions, cobalt ions, chromium ions, or combinations thereof.

18. The method of claim 1 wherein the solid particles of metal-containing ion-dendrimer complexes are separated from the solution by a solid-liquid separation technique.

19. The method of claim 18 wherein the solid-liquid separation technique is selected from the group consisting of cyclone separation, thickening separation, filtration, and combination thereof.

20. The method of claim 1 further comprising spectroscopic monitoring of the presence and/or concentration of the metal-containing ions.

21. A composition comprising:
solid particles formed by reacting a solution having metal-containing ions and associated negative counterions with a dendrimer.

22. The composition of claim 21, wherein the dendrimer is composed of a branched carbon-chain scaffold with functional groups at regular intervals.

23. The composition of claim 21, wherein the dendrimer is composed of a C₂₋₂₀ alkyl-diamine core and amidoamine repeating branches.

24. The composition of claim 23, wherein the C₂₋₂₀ alkyl-diamine core is selected from the group consisting of ethylenediamine, 1,2-diaminododecane, 1,4-diaminobutane, cystamine, 1,6-diaminohexane, and combinations thereof.

25. The composition of claim 21, wherein the dendrimer is composed of a PAMAM.

26. The composition of claim 21, wherein the metal-containing ions include a metal selected from the group consisting of alkali metals, alkaline earth metals, transition metals, lanthanides, actinides, and combinations thereof.

27. The composition of claim 21 wherein the metal-containing ions are actinyl ions.

28. The composition of claim 27 wherein the actinyl ions are selected from the group consisting of UO₂²⁺, NpO₂²⁺, PuO₂²⁺, AmO₂²⁺ and combinations thereof.

29. An inline system for spectroscopically monitoring presence for concentration of metal-containing ions comprises:
a conduit through which a solution having metal-containing ions and associated negative counterions flows.
a spectrophotometer in optical communication with the solution; and
a dendrimer source for providing dendrimers upstream of the spectrophotometer.

30. The inline system of claim 29 further comprising a filter located downstream of spectroscopic system to collect precipitates formed from the reaction of dendrimers with solution.

31. The inline system of claim 29 wherein the spectrophotometer applies UV-visible-NIR absorption and fluorescence spectroscopy.

32. The inline system of claim 29 wherein the spectrophotometer applies UV-visible-NIR absorption and fluorescence spectroscopy.

33. The inline system of claim 29 wherein the dendrimers includes a PAMAM dendrimer selected from the group consisting of PAMAM generation 1 dendrimers, PAMAM generation 2 dendrimers, PAMAM generation 3 dendrimers, PAMAM generation 4 dendrimers, PAMAM generation 5 dendrimers, PAMAM generation 6 dendrimers, PAMAM generation 7 dendrimers, PAMAM generation 8 dendrimers, PAMAM generation 9 dendrimers, and PAMAM generation 10 dendrimers, and combinations thereof.

34. The inline system of claim 29 wherein the metal-containing ions are actinyl ions.

35. The inline system of claim 34 wherein the actinyl ions are selected from the group consisting of UO₂²⁺, NpO₂²⁺, PuO₂²⁺, AmO₂²⁺ and combinations thereof.

36. The inline system of claim 34 wherein the actinyl ions are UO₂²⁺.

37. The inline system of claim 29 wherein the metal-containing ions are lead ions, cadmium ions, copper ions, nickel ions, cobalt ions, chromium ions, or combinations thereof.
